(19) United States
(12) Patent Application Publication
(10) Pub. No.: US 2022/0173615 A1
(43) Pub. Date: Jun. 2, 2022

(54) INDUCTIVE CHARGER

(71) Applicant: IFPL GROUP LIMITED, Isle of Wight (GB)

(72) Inventor: John Michael WRIGHT, Isle of Wight (GB)

(21) Appl. No.: 17/600,863

(22) PCT Filed: Apr. 2, 2020
(86) PCT No.: PCT/EP2020/059458

§ 371 Date: Oct. 1, 2021

(30) Foreign Application Priority Data
Apr. 2, 2019 (GB) 1904636.6

(51) Int. Cl. H02J 50/10; H02J 7/00; B60N 2/90

(52) U.S. Cl. CPC H02J 50/10; H02J 7/0044; H04B 5/0037; B60N 2/90; H02J 7/007

(57) ABSTRACT

An inductive charger (1) for a portable electronic device, RED, which conveniently allows the RED supported at a viewing position and be charged/powered by induction, so that the user can watch media, such as video, whilst the device is being charged. A support surface (la) is arranged in use at an incline to ensure an optimal viewing angle.

### TECHNICAL FIELD

The present invention relates to inductive charging.

### BACKGROUND

Portable electronic devices, PEDs, which may be in the form of a mobile telephone, a tablet computer, a laptop computer, comprise rechargeable batteries. The batteries can be recharged and/or the PED powered by a physical connection (such as a cable connecting the PED to a power supply), or by way of inductive charging. Inductive charging has the benefit that no cable connection is required.

We have devised an inductive charger which more conveniently allows use of the PED during charging/powering.

### SUMMARY

According to a first aspect of the invention there is provided an inductive charger for a portable electronic device, PED, comprising a first support surface and retainer to retain the PED on the surface, and an induction coil located rearwardly of the support surface, wherein, the first support surface is arranged in use at an incline.

The inductive charger may be arranged for installation at the back of a passenger vehicle seat or a bulkhead. The inductive charger may be attached to or incorporated with a rearward part of a passenger seat, which may be the rearward part of a backrest of a passenger seat.

The first support surface may comprise what may be termed an inductive charging pad.

The first support surface may be considered as a mount or holder for a PED to be powered/charged by the inductive loop.

The inductive charger is arranged to provide power and/or charging to the PED.

The support surface is arranged in use at an angle of inclination which corresponds to a viewing angle for a display of the PED. The angle of inclination may be in the range from 20 degrees to 80 degrees from a horizontal plane.

The retainer may comprise a coating or layer which is arranged to provide frictional grip to the PED. The coating or layer may comprise a high frictional surface. The coating or layer may be a polymer material. The coating or layer may comprise a rubberised material. The coating or layer may comprise a non-slip material or substance.

The retainer may comprise a formation which is arranged to locate the PED on the support surface. The formation may comprise a land or a ledge or a sill. The formation comprises a second support surface. The second support surface may be substantially orthogonal to the first support surface. The second support surface may protrude or extend from relative to the first support surface.

The inductive charger may include a slot or channel to receive and locate a lower portion of the PED.

The retainer may comprise a magnet or a magnetised portion.

The inductive charger may comprise a retaining clip to hold PED in place relative to the induction coil more securely. This could be moveable from a retaining position to a release position.

The first support surface may be pivotably mounted, to allow at least one of movement from a stowed condition to deployed condition and vice versa, and selection of angular positions.

The inductive charger may comprise a sensor which is arranged to determine when a PED is on the support surface.

The sensor may comprise a detector which are arranged to determine a change in received light when the PED is present on the support surface.

The sensor may comprise a load cell.

The sensor is preferably incorporated on or in the first support surface.

The inductive charger may comprise a controller and a switch to control activation or energisation to the inductive loop. The controller may be arranged to control the switch such that power is supplied to the inductive loop at least when a PED is determined to be present on the support surface. The controller may be arranged in use to control the switch such that power is not supplied to the inductive loop unless a PED is detected as being present on the support surface.

It may be required that a communications link is established, or a handshake process, between the PED and the inductive charger prior to the inductive loop being powered/energised. This may be effected by the controller.

The controller may be configured to receive a signal from the PED concerning the particular power charging characteristics of the PED. The controller can then regulate the power supplied to the inductive coil accordingly. The controller may after or during a handshake procedure send a request to the PED for its power charging characteristics, or the controller may be arranged to read the information which is passively stored by the PED.

It may be required that for the controller to cause the inductive loop to be energised that the presence of a PED on the support surface is detected and a signal from the PED in response to a polling signal is received by the inductive charger.

The controller may comprise a processor.

The inductive charger may be incorporated into a structure for installation to a passenger vehicle seat or a bulkhead.

The structure may be a generally transverse or laterally extending structure.

The support surface may be fixedly positioned at an incline.

The support surface may be arranged to be moved from a stowed condition to a deployed condition, and vice versa.

An angle of incline of the support surface may be set to one of multiple predetermined settings, or the angle of incline of the support surface may be infinitely adjustable (by the user).

The inductive charger may include a visual indicator to show when the charger is powered and/or in use.

The coil/loop may be embedded onto a circuit board substrate or carrier. This may be termed a printed circuit board coil. The PCB may also incorporate circuitry which is the controller.

A temperature sensor may be used to detect temperature of the emitter. The controller may be arranged to control power to coil in the event that the temperature increases by a predetermined amount or to a predetermined temperature, e.g. to reduce or modulate power supplied to the coil. The temperature may be that of the coil, or a part of the device which is connected to or proximal to the coil, such as internal or external surface of the inductive charging unit. The temperature sensor may comprise a portion of thermochromic material, and a colour wavelength output by the portion of material can be used to determine a prevailing or instantaneous temperature. The thermochromic material may be connected to an optical fibre. The optical fibre may be manufactured from thermochromic material. This can then be utilised to generate a temperature monitoring signal to the controller. Thermochromic blocks may be placed in void regions around the coil. Alternatively, thermochromic fibre could be wrapped around the coil. Further alternatively or in addition, a thin film of the thermochromic material containing the fibre to effectively be a label which is affixed to the unit

The inductive charge coil may typically sit behind a panel through which a magnetic field permeates. The magnetic field engages with a coil within the device to be powered which in turn converts the magnetic flux into volts and amps to either power or to charge the device entered into the magnetic field. The strength of the magnetic field determines how much energy is induced within the coil of the device being placed in the field.

The inductive charger may have a (moveable) top cover and therefore allow exposure of the (transmission) coil to the underside of the mounting surface. The inductive coil may be an ‘open to the elements’, or exposed, coil. The coil may be covered with (only) a minimal or thin or nominal coating or substrate or film or membrane. In these ways we reduce or minimise attenuation of the field which is delivered.

The coil may be encased in or located adjacent to a metal shell or housing or portion, so as to focus/concentrate (forwardly) the field which is generated. This may be termed potting of the coil. The shell/housing/portion may be a ferrite material. The shell/housing/portion may be located behind/underlying/rearwardly of the coil. The shell/housing/portion may comprise a cup component (in which the inductive coil is received).

The coil may formed to have a three-dimensional configuration. This may be used to enhance field strength and/or directivity.

According to a second aspect of the invention there is provided a passenger vehicle seat, which comprises the inductive charger of the first aspect of the invention.

Any of the above aspects of the invention, and further aspects, may comprise one or features disclosed in the drawings and/or in the description, either individually or in combination.

### BRIEF DESCRIPTION OF THE DRAWINGS

Various embodiments of the invention will now be described by way of example only in which:

FIG. 1 is a perspective view of an inductive charger,

FIG. 2 is a schematic cross-sectional view of the inductive charger of FIG. 1 which shows the principal components and sub-assemblies,

FIG. 3 is a perspective view of the charger of FIG. 1 in use with a portable electronic device,

FIG. 4 is a perspective view of a variant embodiment,

FIG. 5 shows an inductive charger incorporated into an aircraft passenger seat, and

FIGS. 6 and 7 show variant embodiments.

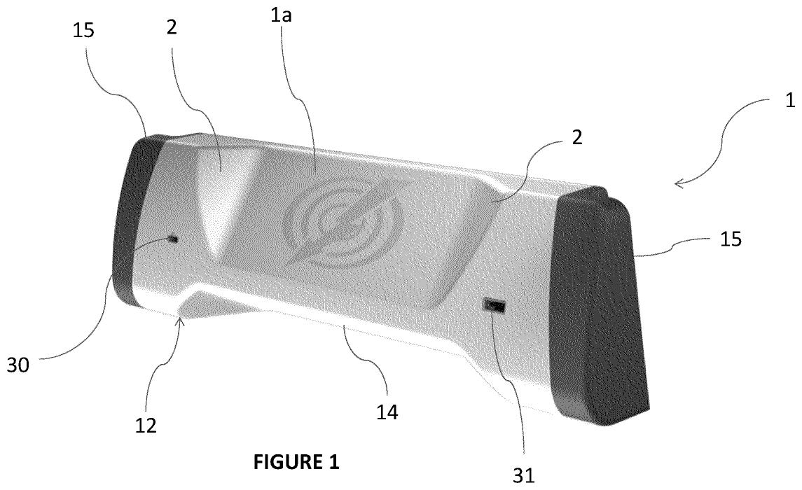

### DETAILED DESCRIPTION

There is now described an inductive charger 1 for a portable electronic device which conveniently allows the PED supported at a viewing position and be charged/powered by induction, so that the user can watch media, such as video, whilst the device is being charged. This is described in relation to installation in a passenger aircraft, and charger could be used in numerous contexts.

The inductive charger 1 comprises a structure, or is incorporated into a structure which comprises a body or carcass 12, and which structure is of generally transverse or lateral form. The body 12 comprises two distal ends 15, which are arranged to be secured to a support structure, such as the back of a passenger aircraft seat. There is provided an intermediate portion 14 which extends between the two distal end portions 15.

The intermediate portion 14 comprises a support surface 1a, on which the PED is retaining during inductive charging, and two side regions 2, which flank the surface 1a. The support surface 1a can be seen as being a recessed region of the body 12.

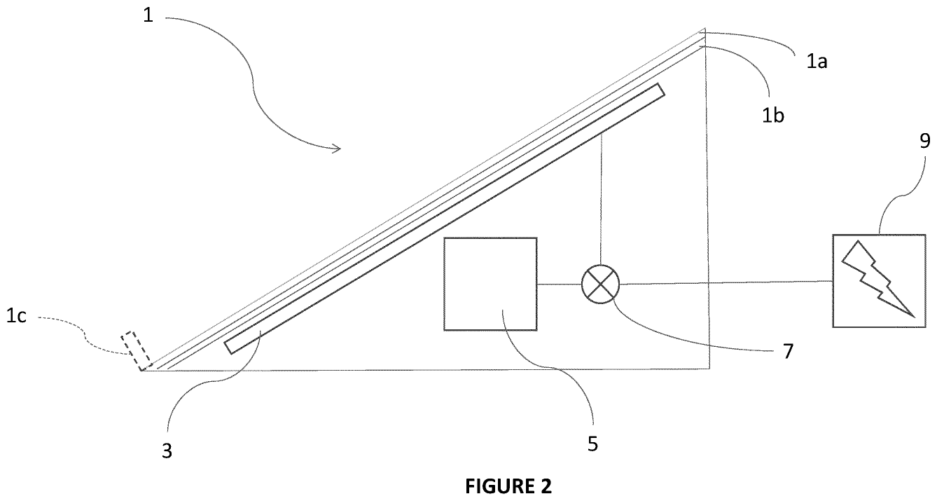

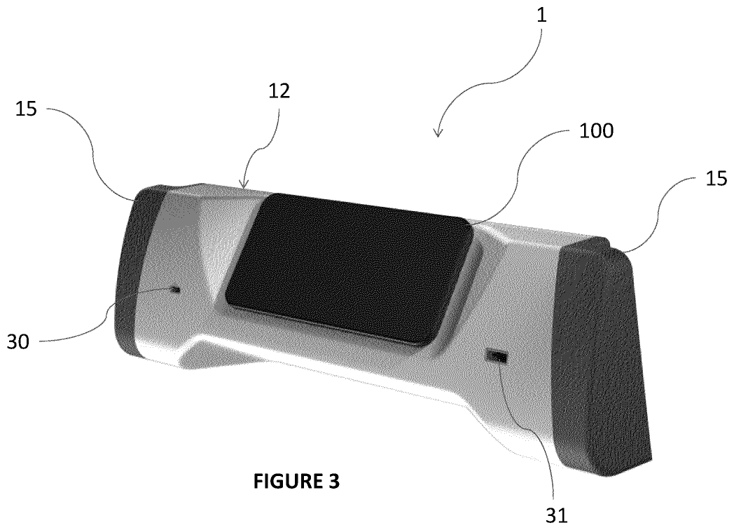

Reference is made to FIG. 2, in which the inductive charger 1 further comprises a controller 5, which controls a power switch or regulator 7. The switch 7 is connected to a power supply 9. A connection is provided between the switch 7 and an inductive coil 3. The inductive coil 3 is provided below a PED support, which comprises an outer high friction surface 1a, and an underlying base 1b. The surface 1a is orientated at an angle to a horizontal plane, which may be between 20 degrees and 80 degrees, or 10 degrees and 85 degrees. Although in the embodiment shown the angle of inclination is fixed, in a variant embodiment the angle of inclination may be adjustable by a user so as to achieve an optimal viewing angle (for example in relation to a user's head position and/or to minimise screen glare). To that end, the PED support may be pivotably mounted, for which see further detail below.

The controller 5 comprises a processor which is configured to require that one or more predetermined criteria are met in order for power to be supplied to the coil 3. These conditions may include one, some or all of the following (which may be termed activation criteria):
the detected presence of a PED on the surface 1a
a handshake protocol between the PED and the controller
receipt of a credential which indicates a user is entitled to use the inductive charger
a manual input (for example an ON/OFF switch provided on the body 12).

In relation to the first listed of the criteria, this could be achieved by way of incorporating an optical sensor, such as a photoelectric diode, within the surface 1a. When the PED is placed on the surface ambient light is prevented from reaching the sensor and therefore generates a signal which indicates that the PED is in place on the charger.

In relation to the second of the listed criteria above, the PED may store a credential or charging token which can be read by the controller. This could take place subsequent to or during a successful handshake signalling/messaging exchange between the PED and the controller. In this regard, the PED preferably has installed a software application or app, which allows the controller to request the credential and/or for the PED to output the credential on receipt of a signal from the controller. The exchange of the credential data is preferably achieved by use of an air interface communications protocol such as Bluetooth® or Wifi. However, the exchange of data between the controller and the PED may be effected through a wired or cable connection.

The body 12, on a front or forward facing surface is provided with two electrical connectors, each of a different type (for example conforming to different recognised standards, such as a USB socket). One or both of the connectors may provide connectivity to the power supply 9 and/or to a data network or data resource. In use, the inductive charger 1 operates as follows. A user places his/her PED 100 onto the surface 1a. The high friction surface 1a retains the PED in position on the surface and prevents gravity from causing it to slip. Once in place on the surface, the controller 5 determines that a PED is positioned on the charger 1. The controller may execute a messaging or signalling exchange with the PED so as to determine/negotiate power charging characteristics and/or to receive a required credential stored by the PED. It will be appreciated that the induction coil 3 is not energised until the activation criteria are met. Therefore, when not in use, the induction coil is not activated.

Once the induction coil is activated, the PED 100 can be powered whilst at the same time allowing a user to view media shown on the display of the PED.

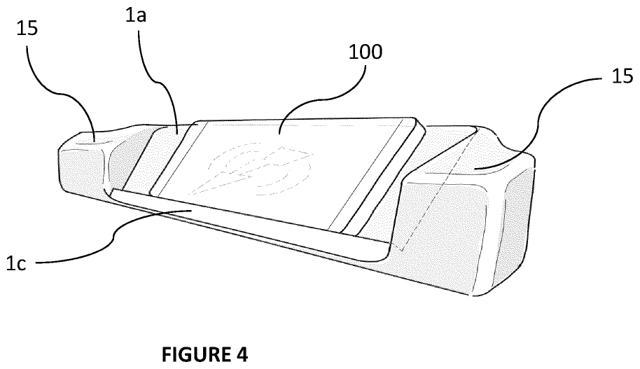

Finally, returning to FIG. 2, this shows a variant embodiment in which a second support surface 1c is provided to wholly or in part locate the PED in position on the support surface 1a. In this embodiment, the use of a high friction surface may be redundant. This embodiment is also shown in FIG. 4.

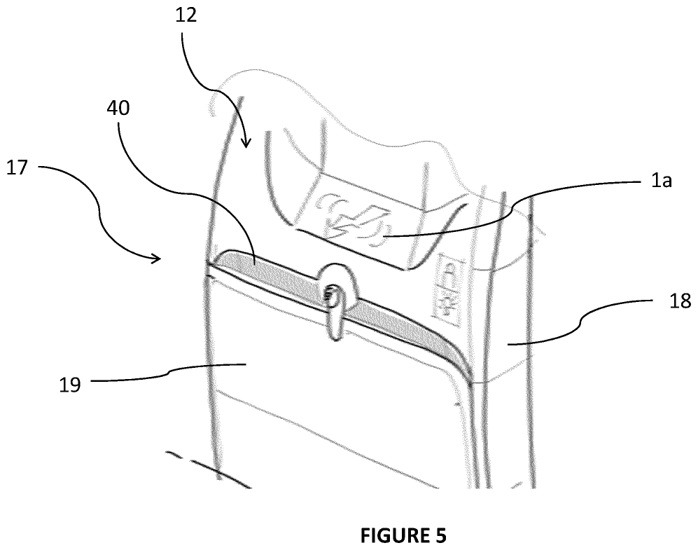

Reference is made to FIG. 5 which shows how the structure 12 may be incorporated into, or attached to a passenger seat of an aircraft. The structure 12 is provided at the rearward part of a back rest 18 of a passenger seat 17. Below the structure 12 there is provided a tray table 19. The structure 12 may be provided at a lower region thereof with a light, arranged to emit light towards a passenger so as to illuminate the passenger's space.

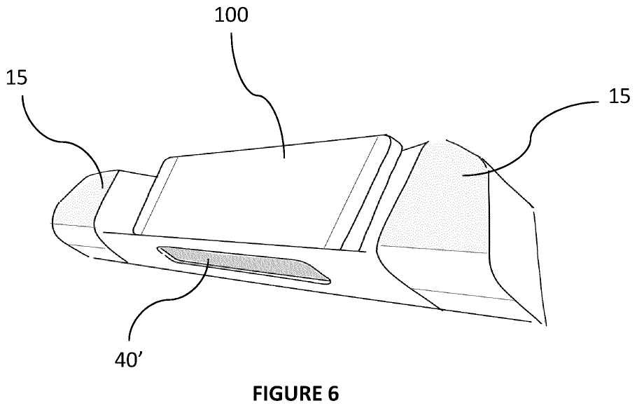

FIG. 6 shows an embodiment of the structure 12 which comprises a light 40′.

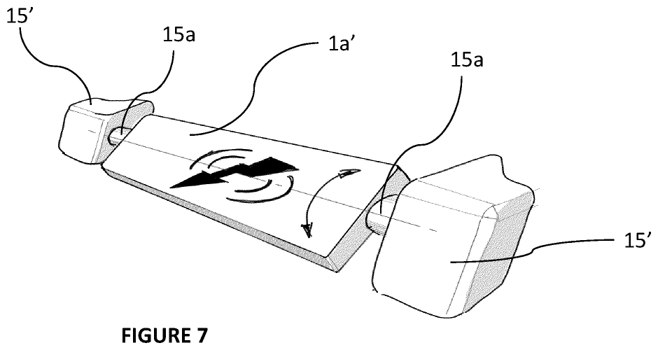

FIG. 7 shows an inductive charger in which a support surface 1a′ is pivotably mounted between two end portions 15′ by way of stub shafts 15a. This allows a user to select the most suitable or convenient orientation, which allows the PED to be used whilst receiving power by induction.

The inductive charger could be alternatively embodied, such as provided in a surface, a table top, a tray table or mount it behind a surface.

In yet a further possible embodiment, the inductive charger may comprise a light or visual indicator which shows that the charger is in use or operative.

1. An inductive charger for a portable electronic device, PED, comprising a first support surface and retainer to retain the PED on the surface, and an induction coil located rearwardly of the support surface, wherein, the first support surface is arranged in use at an incline.

2. A charger as claimed in claim 1 which is arranged for installation at the back of a passenger vehicle seat or in a bulkhead.

3. A charger as claimed in claim 2 is arranged to be attached to or incorporated with a rearward part of a passenger seat, which may be the rearward part of a backrest of a passenger seat.

4. A charger as claimed in any preceding claim in which the first support surface is a mount or holder for a PED to be powered/charged by the inductive loop.

5. A charger as claimed in any preceding claim in which the support surface is arranged in use at an angle of inclination which corresponds to a viewing angle for a display of the PED, and the angle of inclination is preferably in the range from 20 degrees to 80 degrees from a horizontal plane.

6. A charger as claimed in any preceding claim in which the retainer comprises a coating or layer which is arranged to provide frictional grip to the PED.

7. A charger as claimed in any preceding claim in which the retainer comprises a formation which is arranged to locate the PED on the support surface.

8. A charger as claimed in any preceding claim in which the first support surface is pivotably mounted, to allow at least one of movement from a stowed condition to deployed condition and vice versa, and selection of angular positions.

9. A charger as claimed in any preceding claim which comprises a sensor which is arranged to determine when a PED is on the support surface.

10. A charger as claimed in any preceding claim which comprises a controller and a switch to selectively control activation or energisation to the inductive loop.

11. A charger as claimed in claim 10 in which the controller is configured to receive a signal from the PED concerning the particular power charging characteristics of the PED.

12. A charger as claimed in claim 11 in which the controller can then regulate the power supplied to the inductive coil in response to the signal.
